(19) United States
(12) Patent Application Publication
(10) Pub. No.: US 2016/0358679 A1
(43) Pub. Date: Dec. 8, 2016

(54) SYSTEMS AND METHODS FOR DETERMINING AN AMOUNT OF FISSILE MATERIAL IN A REACTOR

(71) Applicants: BATTELLE ENERGY ALLIANCE, LLC, Idaho Falls, ID (US); OREGON STATE UNIVERSITY, Corvallis, OR (US)

(72) Inventors: SEAN R. MORRELL, POCATELLO, ID (US); THOMAS V. HOLSCHUH, CORVALLIS, OR (US); WADE R. MARCUM, CORVALLIS, OR (US); DAVID L. CHICHESTER, IDAHO FALLS, ID (US)

(21) Appl. No.: 15/171,740

(22) Filed: Jun. 2, 2016

Related U.S. Application Data
(60) Provisional application No. 62/171,824, filed on Jun. 5, 2015.

(51) Int. Cl. G21C 17/06; G21C 17/108

(52) U.S. Cl. CPC G21C 17/06; G21C 17/108; G21Y 2002/204

(57) ABSTRACT

A method of determining an amount of fissile material in a reactor includes sensing neutrons or photons emitted from the reactor before and after a change in a reactor operating parameter and determining a mass of fissile material responsive to a difference between the intensities of the radiation. A system for determining an amount of fissile material includes a radiation detector and a computing system. The radiation detector may be configured to detect neutrons or photons. The computing system may be configured for calculating mass of the fissile material based at least in part on a change in the power output from the reactor as a function of time. Some methods include collecting radiation emitted by a reactor, generating an electrical signal responsive to the collected radiation, and evaluating mass of the fissile material responsive to the magnitude and response of the electrical signal after a change in the reactor.

### CROSS-REFERENCE TO RELATED APPLICATION

This application claims the benefit of U.S. Provisional Patent Application Ser. No. 62/171,824, filed Jun. 5, 2015, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### FIELD

Embodiments of the present disclosure relate generally to systems and methods for determining an amount of fissile material in a nuclear reactor, particularly while the reactor is in operation.

### BACKGROUND

Uncontrolled nuclear materials are a real and present concern because such materials may fall into the hands of rogue states or terrorist organizations. National and international organizations work to alleviate the problems of uncontrolled nuclear materials by reducing and protecting vulnerable nuclear and radiological materials located at civilian sites worldwide, deterring potential non-compliers with costly penalties, and helping parties demonstrate non-proliferation undertakings. In order to focus resources more effectively, inspection and enforcement resources tend to be focused at sites having particularly high risk of loss of nuclear material. The aggregate risk of nuclear proliferation on citizens worldwide has reduced dramatically based on the work of such organizations, but continued enforcement and improvements in inspection and enforcement can help to limit future risks and future costs associated with uncontrolled nuclear materials, both in short and long terms.

One difficulty in tracking nuclear materials is that it is generally difficult to identify, by non-invasive means, the quantity of fissile material in on-line (i.e., operating) nuclear reactors, such as research reactors. Thus, to accurately determine the quantity of fissile material by conventional means, a reactor typically must be taken off-line so that material can be handled and inspected.

Cherenkov (or \check{C}erenkov) radiation is electromagnetic radiation emitted when a charged particle (e.g., an electron) passes through a dielectric medium at a speed greater than the phase velocity of light in that medium. Though electrodynamics limits the speed of light in a vacuum to a universal constant (c), the speed at which light propagates in a material may be significantly less than c. Matter can be accelerated beyond this speed (although still to less than c) during nuclear reactions and in particle accelerators. Cherenkov radiation results when a charged particle, most commonly an electron, travels through a dielectric (electrically polarizable) medium with a speed greater than the speed at which light propagates in the same medium. Cherenkov radiation can occur in the range of visible light, UV light, and any frequency range where the emission condition can be met, i.e., in the radiofrequency range.

A Cherenkov detector is a particle detector using the speed threshold for light production, the speed-dependent light output, or the velocity-dependent light direction of Cherenkov radiation. Such detectors are described in, for example, U.S. Pat. No. 3,600,578, issued Aug. 17, 1971, titled “Reactor Power Level Sensing Device Using Cherenkov Radiation;” U.S. Pat. No. 4,389,568, issued Jun. 21, 1983, titled “Method for Monitoring Irradiated Nuclear Fuel Using Cerenkov Radiation;” and U.S. Patent Application Publication 2011/0163236, published Jul. 7, 2011, titled “Scintillation-Cherenkov Detector and Method for High Energy X-Ray Cargo Container Imaging and Industrial Radiography,” the entire disclosure of each of which is hereby incorporated by reference. Cherenkov detectors situated remote from a specimen can measure the Cherenkov light emitted from the specimen, and this can be correlated to the intensity of ionizing radiation emitted from the specimen. However, this relative intensity appears to be unrelated to quantities of fissile material present.

### BRIEF SUMMARY

In some embodiments, a method of determining an amount of fissile material in a reactor includes sensing a first intensity of at least one of neutrons or photons emitted from a reactor, sensing a second intensity of at least one of neutrons or photons emitted from the reactor after a change in an operating parameter of the reactor; and determining a mass of a fissile material within the reactor responsive to a difference between the first intensity and the second intensity. The intensities may be measured as trends over a period of time. For example, the first intensity and the second intensity may be extracted from a continuous measurement of the neutrons or photons over a period of time.

In certain embodiments, a system for determining an amount of fissile material in a reactor includes a radiation detector and a computing system. The radiation detector may be configured to detect at least one of neutrons or photons emitted from a reactor. The computing system may be configured for operable communication with the radiation detector to receive a measurement corresponding to an intensity of the at least one of neutrons or photons. The computing system may include a memory configured for storing computing instructions and a processor operably coupled to the memory and configured for executing the computing instructions to calculate a power output from the reactor responsive to the intensity of the at least one of neutrons or photons. The processor may be further configured for calculating a mass of fissile material within the reactor based at least in part on a change in the power output from the reactor as a function of time.

In other embodiments, a method includes collecting an initial radiation measurement of emissions emitted by a reactor, generating a baseline electrical signal responsive to the collected initial radiation measurement, changing a reactivity of the reactor, sensing a change in radiation emitted by the reactor, generating a second electrical signal responsive to the change in radiation during the change in the reactivity of the reactor, and evaluating a mass of fissile material within the reactor responsive to a magnitude and response of the second electrical signal.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified schematic diagram illustrating a system for determining an amount of fissile material in accordance with some embodiments disclosed herein; and

FIGS. 2 and 3 are graphs showing theoretical power outputs from reactors after perturbations.

### DETAILED DESCRIPTION

Methods and devices disclosed herein for determining an amount of fissile material (e.g., plutonium) in a reactor may be used to monitor research reactors and other facilities at risk of diversion of fissile material for unauthorized use (e.g., for weapons). In some embodiments, methods may include sensing neutrons or photons (e.g., Cherenkov light) or both before and after a change in an operating parameter of the reactor and determining a mass of the fissile material within the reactor based at least in part on a difference between the first intensity and the second intensity.

The illustrations presented herein are not actual views of any particular device, but are merely idealized representations that are employed to describe example embodiments of the present disclosure.

As used herein, the term “response time” means the time required for an output signal of a detector to change from 10% of a peak output value to 90% of the peak output value. Response time depends on the type of detector, materials of construction, size, and other factors. Response time is further described in OPTO-SEMICONDUCTOR HANDBOOK, Chapter 2 (Si Photodiodes), p. 8, (Hamamatsu Photonics, 2013) available on the Internet at hamamatsu.com/resources/pdf/ssd/e02_handbook_si_photodiode.pdf, the disclosure of which is hereby incorporated herein in its entirety by reference.

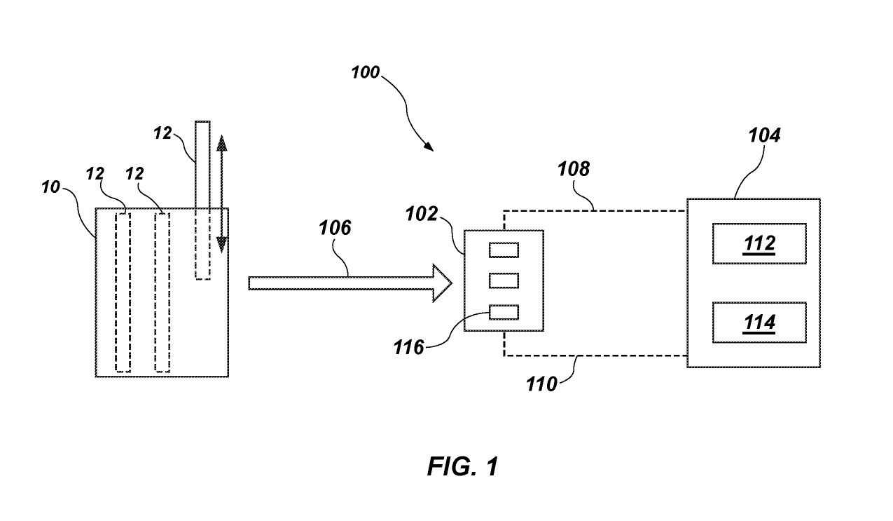

FIG. 1 is a simplified schematic diagram illustrating a system 100 for determining an amount of fissile material in accordance with some embodiments disclosed herein. The system 100 includes a radiation detector 102 and a computing system 104. The radiation detector 102 may be configured to detect neutrons or photons 106 (or both) emitted from fissile material within a reactor 10 or another material associated with the reactor 10 (e.g., from cooling water). Photons may include any electromagnetic radiation, such as Cherenkov light. The computing system 104 may be configured to communicate with the radiation detector 102 to receive a signal 108 corresponding to an intensity of the neutrons or photons 106, and to provide the radiation detector 102 with a ground 110, a power supply, or any other appropriate connection. The computing system 104 may include a memory 112 configured for storing computing instructions and a processor 114 configured for calculating a power output from the reactor 10 responsive to the signal 108 (which is, in turn, responsive to the intensity of the neutrons or photons 106). The processor 114 may be further configured for calculating a mass of the fissile material in the reactor 10 responsive to a change in the power output from the reactor 10 as a function of time.

The radiation detector 102 may be, for example, a photon flux monitor, an ionization chamber, a proportional counter, a neutron flux monitor, a fission chamber, a self-powered photon detector, a photodiode, a photomultiplier tube, a charge-coupled device, a camera, or any other device capable of generating the signal 108 based at least in part on the neutrons or photons 106. The radiation detector 102 may be selected to have a response time of less than about 10 ms (milliseconds), less than about 1 ms, less than about 100 μs (microseconds), less than about 10 μs, or even less than about 1 μs. The radiation detector 102 may be mounted in an in-core or ex-core position (i.e., within the reactor 10 or external to the reactor 10).

Based at least in part on the signal 108 received from the radiation detector 102, the processor 114 may be configured for calculating relative amounts of radioisotopes in the fissile material. The calculation may be based at least in part on the change in the power output from the reactor 10 as a function of time or position. Furthermore, the processor 114 may be configured to compare the power output from the reactor 10 to a theoretical power output based at least in part on a known composition and quantity of fissile material.

A method for using the system 100 to determine an amount of fissile material in a reactor 10 may include sensing a first intensity of neutrons or photons 106 emitted from fissile material within a reactor 10, sensing a second intensity of neutrons or photons 106 emitted from the fissile material after a change in an operating parameter of the reactor 10, and determining a mass of the fissile material within the reactor 10 based at least in part on a difference between the first intensity and the second intensity. In some embodiments, the intensity of neutrons or photons 106 may be monitored to generate a continuous or near-continuous record of intensity.

In certain embodiments, the radiation detector 102 may include a plurality of sensors 116, each configured to detect neutrons or photons emitted from different locations within a reactor. Thus, the radiation detector 102 may be used to collect spatially dependent information about the radioactive fuel composition throughout the reactor 10. For example, the sensors 116 may be configured to detect neutrons or photons emitted from next to or in between individual fuel assemblies within the reactor 10, as well as neutrons or photons emitted from individual fuel assemblies themselves.

The system 100 may be used to evaluate fissile material without interfering with or altering operation of the reactor 10. The reactor 10 may be operated according to normal procedures, and an inspection team using the system 100 may measure neutrons or photons 106 emitted in the normal course of operation of the reactor 10 during and after a change in an operating parameter.

For example, the change in an operating parameter may, in one embodiment, be initiated by insertion or removal of a control rod 12. The neutrons or photons 106 may be detected and measured for a period of time surrounding a perturbation from a steady state. By removing a control rod 12 without changing other operating parameters, power generated by a reactor 10 may increase. Inserting a control rod 12 may have an opposite effect, decreasing power output. As known in the art, control rods 12 may be removed and inserted as necessary to meet power generation requirements. A change in the number of control rods 12 in a reactor 10 provides a useful point for measuring changes in the neutrons or photons 106.

In some embodiments, the change in an operating parameter may be initiated by a change in the number of fuel rods in a reactor 10, but such changes are generally less frequent, and may typically occur when the reactor 10 is not in operation.

In other embodiments, the change in an operating parameter may be initiated by a change in temperature (e.g., via a change in a flow rate of a cooling fluid), pressure, or any other parameter.

The radiation detector 102 may be configured to detect the neutrons or photons 106 for a period of time before and after the change in the operating parameter. The radiation detector 102 may detect the intensity of the neutrons or photons 106 for a period of time sufficient to correlate the steady-state condition of the reactor 10 to a particular intensity of neutrons or photons 106. The radiation detector 102 may detect trends or changes in the neutrons or photons 106 over a period of time. In some embodiments, the radiation detector 102 may detect the neutrons or photons 106 for at least 1.0 seconds before the change in the operating parameter, at least 10 seconds before the change in the operating parameter, or even at least 60 seconds before the change in the operating parameter. Measurement over a period of time may also be beneficial for improving a signal-to-noise ratio and improving detection capabilities.

The radiation detector 102 may continuously measure the neutrons or photons 106 during and after the change in the operating parameter. In some embodiments, the radiation detector 102 may detect the neutrons or photons 106 for at least 1.0 seconds after the change in the operating parameter, at least 10 seconds after the change in the operating parameter, or even at least 60 seconds after the change in the operating parameter. However, some effects of the change in the operating parameter may be more immediate, occurring less than 100 milliseconds (ms) after the change in the operating parameter, less than 50 ms after the change in the operating parameter, or even less than 20 ms after the change in the operating parameter.

The radiation detector 102 may measure the intensity of the neutrons or photons 106 as a function of time, and may measure the period of time from the change in the operating parameter until a change in the neutrons or photons 106 occurs. The time until a change in the neutrons or photons 106 occurs may be useful for characterizing the fissile material, and may be used in conjunction with a magnitude of the intensity change to characterize the fissile material (e.g., to determine mass or composition of the fissile material).

The radiation detector 102 and/or the computing system 104 may quantify the intensity of the neutrons or photons 106 as a function of time or position. For example, if the radiation detector 102 transmits a signal 108 (e.g., a voltage, a current, etc.) to the computing system 104, the computing system 104 may translate that signal 108 into an intensity of the neutrons or photons 106. The intensity of the neutrons or photons 106 may be measured at a selected wavelength or over a range of wavelengths. For example, the intensity of the neutrons or photons 106 may be measured in a range from about 200 nm to about 400 nm, such as from about 250 nm to about 350 nm, or from about 280 nm to about 320 nm.

Though the intensity of the neutrons or photons 106 does not necessarily correspond to any parameter of interest in the monitoring of fissile materials, the change in the intensity of the neutrons or photons 106 after a change in a reaction parameter can be correlated to the composition of the fissile material based at least in part on reaction kinetics. For example, if the radioisotopes ²³⁵U (uranium-235 or U-235) and ²³⁹Pu (plutonium-239 or Pu-239) are both present in a sample, the system 100 may determine relative quantities of each of these radioisotopes. If the magnitude of the change in the operating parameter is known, the amount of the fissile material may also be determined. The relationship between the intensity of neutrons or photons 106 and the mass of fissile material is explained in further detail in the Examples below, and in Thomas Holschuh et al., “Non-Proliferation Application of Off-the-shelf Detector(s) for Research Reactors,” Institute of Nuclear Materials Management Annual Meeting, Atlanta, Ga., United States, pp. 1-10, Jul. 20-24, 2014, the entire disclosure of which is incorporated herein by this reference. Once the relative quantities of each radioisotope and the mass of fissile material are known, the mass of an individual radioisotope can be calculated.

In some embodiments, an operator of a reactor 10 may make statements about the amount and type of materials present in the reactor 10. Information from the system 100 may be used to verify the veracity of such statements, and may assist regulators in limiting the opportunities for reactor 10 operators or others to divert fissile materials. For example, Pu-239 is particularly valuable for making nuclear weapons, and so regulators may be particularly interested in ensuring that the amounts of this radioisotope present match the official records.

In some embodiments, the radiation detector 102 may be placed in close proximity to the fissile material. For example, the radiation detector 102 may be placed adjacent to the reactor 10 or in a fluid in which the fissile material is immersed (e.g., the radiation detector 102 may be placed underwater). The radiation detector 102 may detect neutrons or photons 106 from a single fuel element (e.g., a fuel rod) of a reactor 10, from a defined area of a reactor 10, or from the whole core of the reactor 10. In some embodiments, the radiation detector 102 may detect neutrons or photons 106 from an area smaller than about 0.1 m² (square meters), smaller than about 0.01 m², or even smaller than about 0.001 m².

The power produced by fission in a reactor 10 is driven by the neutron population in the reactor 10. Some of the neutrons may influence power output immediately, which may be referred to in the art as a “prompt effect,” and others may influence power output over time, which may be referred to in the art as a “delayed effect.” The neutrons related to the delayed effect are produced by the decay of fission products, and therefore the delayed effect corresponds to the half-lives of radioisotopes in the reactor 10. Quantifying how the delayed effect changes after perturbation of an operating parameter can assist in quantifying the radioisotopes present because each radioisotope emits radiation at a known rate related to the half-life of the radioisotope and the mass of the radioisotope present.

Systems and methods as disclosed herein may provide additional information that is not available from conventional equipment (e.g., conventional Cherenkov detectors). In particular, by using the systems and methods disclosed herein, information may be collected related to the prompt fraction of neutrons, which may be useful in identifying the composition of nuclear fuel, and, by extension, the amounts of materials present in an operating reactor 10. The efficiency of the systems and methods may be improved by, for example, collimating the light detected, providing a band-pass filter, locating the radiation detector 102 in close proximity to the fissile material, or other optimization of the radiation detector 102 or the computing system 104. The radiation detector 102 may be configured to provide a relatively higher signal-to-noise ratio than conventional Cherenkov detectors, and may be configured to have relatively shorter collection times than conventional Cherenkov detectors.

### EXAMPLES

### Example 1

A numerical simulation was performed based on two identical point reactors (i.e., theoretical reactors in which all fissile material is concentrated at a single point), one containing pure U-235 and the other containing pure Pu-239. The neutrons and power output in each reactor were modeled as a function of time after a causing a change in reactivity in the reactor (e.g., by removing or inserting a control rod). Assuming that at the time immediately before the change, the reactor power and the composition are unchanging, the reactor power after the change can be approximated by the following relationship:

P(t)=P₁e^{s}^{₁}^{t}+P₂e^{s}^{₂}^{t} (Equation 1),

where the first term approximates the immediate initial change (sometimes referred to as the “prompt jump”) and the second term approximates the long-term slope of the power curve. Equation 1 may be referred to as the “prompt-jump approximation.” The derivation of this relationship and the meaning of the variables are further described in Thomas Holschuh et al., “Non-Proliferation Application of Off-the-shelf Detector(s) for Research Reactors,” pp. 2-4, previously incorporated by reference. Differences in the composition of the fuel cause differences in the terms of this relationship, based on changes in the reactor. Table 1 qualitatively compares the changes in each of the terms of Equation 1 between a theoretical reactor having pure U-235 and Pu-239 for two types of change: 1) a control rod insertion or removal at constant reactivity, and 2) insertion or removal of fuel at constant $ value (defined as reactivity divided by delayed-neutron fraction).

TABLE 1
Changes in terms of Equation 1

| | Type of change | |
|---|---|---|
| | Constant reactivity insertion | Constant $ insertion |
| Term | (control rod) | (fuel) |
| P₁ | Change is larger for Pu-239 | Change is equal for Pu-239 |
| | than for U-235 | and U-235 |
| P₂ | Change is larger for Pu-239 | Change is equal for Pu-239 |
| | than for U-235 | and U-235 |
| s₁ | Change is larger for Pu-239 | Change is nearly equal for |
| | than for U-235 | Pu-239 and U-235 |
| s₂ | U-235 has larger magnitude | U-235 has larger magnitude |
| | (values are negative for both U-235 | (values are negative for both |
| | and Pu-239) | U-235 and Pu-239) |

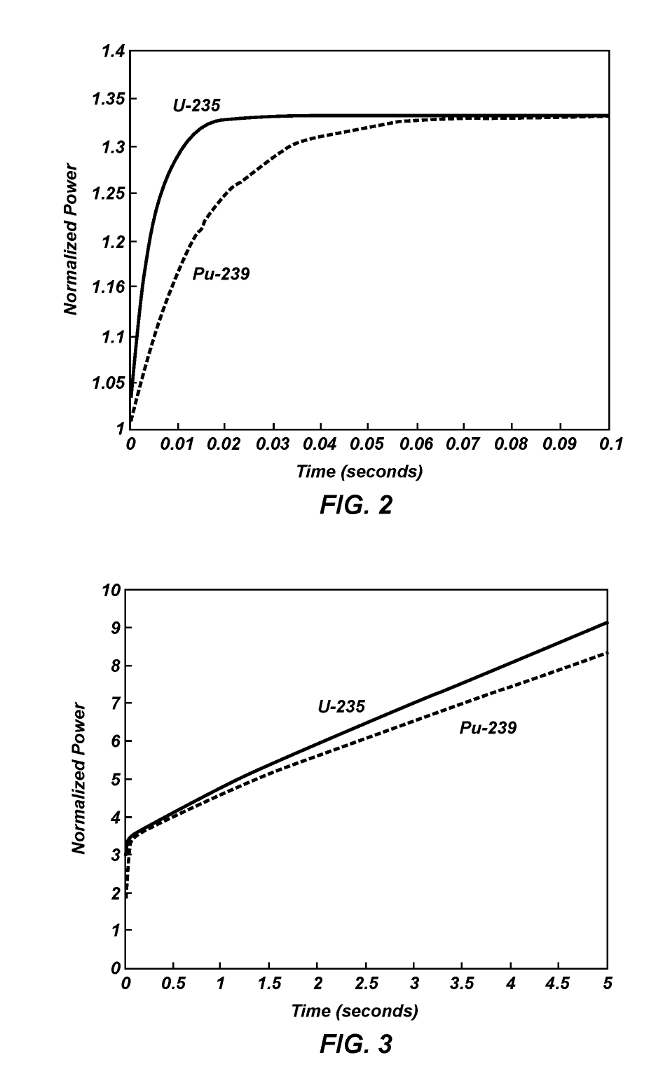

FIG. 2 shows theoretical normalized power outputs based on prompt neutrons from point reactors containing pure Pu-239 and U-235 based on a constant $ insertion of $0.25×β_{Pu-239}. After about 0.1 s, the difference between the power output based on Pu-239 and U-235 becomes very small. Thus, to detect any difference between Pu-239 and U-235 in this constant $ insertion scenario, the prompt jump power output should be measured quickly. A photodiode with a short response time (e.g., less than 0.01 second) may be selected to detect differences in this scenario.

FIG. 3 shows theoretical normalized power outputs overall from point reactors containing pure Pu-239 and U-235 based on a constant $ insertion of $0.25×β_{Pu-239}. The difference between Pu-239 and U-235 increases as a function of time for the time scale of this simulation.

In both FIG. 2 and FIG. 3, there is a measurable difference between the power outputs of Pu-239 and U-235. Thus, the measured intensity as a function of time can be used in part to determine the ratio of Pu-239 to U-235 in the reactor.

At short times after insertion, the fraction of Pu-239 will be small compared to the fraction of U-235, based on the shorter half-life of Pu-239 and because U-235 is a decay product of Pu-239. Thus, the reactor power changes in part due to the decreased amount of Pu-239. Therefore, it may be difficult to discern between relatively small concentrations of Pu-239 based on kinetic parameters alone.

### Example 2

Numerical simulations were performed based on identical point reactors (i.e., theoretical reactors in which all fissile material is concentrated at a single point), containing pure U-235 or pure Pu-239. Normalized power (P₁ in Equation 1) was calculated for each reactor based on different amounts of reactivity inserted, and the results are shown in Table 2.

TABLE 2

| Amount of Positive | Normalized Power | Normalized Power |
|---|---|---|
| Reactivity Inserted | (P₁) for U-235 | (P₁) for Pu-239 |
| ρ = $0.10 × β_{Pu-239} | 1.033 | 1.111 |
| ρ = $0.20 × β_{Pu-239} | 1.068 | 1.250 |
| ρ = $0.30 × β_{Pu-239} | 1.106 | 1.429 |
| ρ = $0.40 × β_{Pu-239} | 1.146 | 1.667 |
| ρ = $0.50 × β_{Pu-239} | 1.190 | 2.000 |

The calculations reported in Table 2 are for pure U-235 or Pu-239 cores. In a mixture, as would be expected in reactor fuel, properties may be a weighted average of the properties of the constituent materials, including fission products of the starting materials. However, Table 2 illustrates that a larger reactivity insertion, up to the limit of p=$0.50×β_{Pu-239} imposed by this approximation, creates a larger margin between the prompt jumps in power for the two fuel materials, U-235 and Pu-239. Thus, a larger reactivity insertion should make discerning differences in the composition of the reactor fuel relatively easier (i.e., relatively smaller differences in composition can be detected after a relatively larger reactivity insertion).

### Example 3

It is important for inspectors to have the capability to ascertain the fuel composition of a research reactor suspected of diverting material, such as Pu-239. Therefore, reactor operations may be disguised to match expected values in an attempt to deceive inspectors. Table 3 is a side-by-side comparison of parameters that may be measured depending on whether the reactor operator has provided correct or incorrect information about the amount of reactivity inserted into a reactor. That is, the terms shown in Table 3 may vary if the reactivity insertion amount is adjusted in an attempt to compensate for an amount of Pu-239 being diverted. The information in Table 3 can assist in detecting such deception.

TABLE 3

| Term | Reactivity Insertion is Truthful | Reactivity Insertion is Falsified |
|---|---|---|
| P₁ | Greater than expected | Same as expected |
| P₂ | Greater than expected | Same as expected |
| s₁ | Greater than expected | Same as expected |
| s₂ | Smaller than expected | Smaller than expected |

Fuel diversion is easier to discern if the reactor operators insert the expected level of reactivity with unexpected kinetics parameters. However, if the reactor operators attempt to deceive inspectors by inserting a “compensated” amount of reactivity to balance the kinetics parameters that exist due to their material diversion, the number of terms available to determine a difference is significantly reduced. It may be possible to detect a difference with only the s₂ term, which is the exponential portion of the second term in the prompt jump approximation that represents an “approach” to steady state. This “approach” is extremely short, on the order of 10⁻³ s, and miniscule amounts of material diversion may not make a detectable impact on this quantity.

### Example 4

To investigate the plausibility of determining the s₂ term (i.e., the only term that cannot be falsified by reactor operators), numerical analysis was performed using a 1 MWₜₕ research reactor. Table 4 provides the kinetics parameters for the reactor at various points in its operating cycle. The delayed neutron fraction is greater than β_{eff}^{U-235} due to the inclusion of U-238 in the fuel material. The β_{eff} at beginning-of-life (BOL) decreases to a middle-of-life (MOL) value due to the accumulation of plutonium in the reactor core. Then, the associated buildup of transuranic elements slightly increases the β_{eff} value at the end-of-life (EOL). In addition, the prompt neutron lifetime also changes throughout the reactor's operating cycle, which alters the mean neutron generation time, A.

TABLE 4
Kinetics Parameters for Example 4 at various points in operating cycle

| | BOL value | MOL value | EOL value |
|---|---|---|---|
| Delayed | 0.0076 ± 0.0001 | 0.0073 ± 0.0002 | 0.0075 ± 0.0002 |
| Neutron | | | |
| Fraction (β_{eff}) | | | |
| Prompt | 22.6 ± 2.9 | 19.0 ± 1.9 | 30.7 ± 2.8 |
| Neutron | | | |
| Lifetime (l) | | | |
| (10⁻⁶ s) | | | |

A term X can be defined as a fraction relating the second term of Equation 1 to the reactor power P(t):

$$X = \frac{{P}_{2} {e}^{{s}_{2} t}}{P ( t )} , \qquad ( Equation 2 )$$

and the time to achieve a selected X value can be calculated. For the reactor of Example 4, the times (t) required to achieve various X values are shown in Table 5.

TABLE 5
Estimation of approach time for Example 4 at various points in
operating cycle

| Fraction | | | |
|---|---|---|---|
| X | t at BOL value (ms) | t at MOL value (ms) | t at EOL value (ms) |
| 0.75 | 4.11 | 3.59 | 5.65 |
| 0.90 | 9.53 | 8.35 | 13.13 |
| 0.95 | 13.64 | 11.94 | 18.78 |
| 0.99 | 23.18 | 20.29 | 31.90 |

As shown in Table 5, the available window in which to determine the transient power level of a reactor in response to a perturbation may be from about 4 ms to about 32 ms.

### Example 5

### Inspection Technique

An inspector of a facility may use a detector as follows to inspect a facility to determine whether fuel is being diverted:
1) Request β_{eff} and prompt neutron lifetime (l) values from reactor staff.
2) Using a scintillation detector, determine a baseline photon flux from Cherenkov light.
3) Request a $0.50×β_{Pu-239} square wave to be performed in the reactor.
4) Using the scintillation detector, measure the increase in photon flux from the light. As the power increases, it will approach a linear trend (on a logarithmic plot) until approximately 5 s to 7 s following the square wave as negative feedback mechanisms begin to dominate.
5) Extrapolate the linear trend to a t=0 condition, which yields the prompt jump value and the entire first term of Equation 1.
6) Select a value of X (e.g., 0.99 or higher, to ensure the largest margin of time) and calculate the time to reach X.
7) Compare the measured photon flux to the first term of Equation 1 determined in step 5. If the “approach” time for these two equations is greater than the calculated time from step 6, including associated uncertainty, then the fuel composition in the research reactor differs from what the reactor operator claims. Corrective action can then be taken.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention. Further, embodiments of the disclosure have utility with different and various detector types and configurations.

What is claimed is:

1. A method of determining an amount of fissile material in a reactor, the method comprising:
sensing, with a radiation detector, a first intensity of at least one of neutrons or photons emitted from a reactor;
sensing, with the radiation detector, a second intensity of at least one of neutrons or photons emitted from the reactor after a change in an operating parameter of the reactor; and
determining a mass of fissile material within the reactor responsive to a difference between the first intensity and the second intensity.

2. The method of claim 1, further comprising:
determining a first composition of the fissile material within the reactor responsive to the first intensity of the at least one of neutrons or photons emitted therefrom; and
determining a second composition of the fissile material within the reactor responsive to the second intensity of the at least one of neutrons or photons emitted therefrom after the change in the operating parameter of the reactor.

3. The method of claim 1, further comprising comparing the determined mass of the fissile material within the reactor with a mass of fissile material reported by an operator of the reactor.

4. The method of claim 1, further comprising initiating the change in the operating parameter by purposefully perturbing the reactor from a steady state.

5. The method of claim 4, wherein purposefully perturbing the reactor from a steady state comprises at least one of inserting a control rod to the reactor and removing a control rod from the reactor.

6. The method of claim 1, wherein each of sensing the first intensity of at least one of neutrons or photons and sensing the second intensity of at least one of neutrons or photons comprises sensing at least one of neutrons or photons within a fluid in which the fissile material and the radiation detector are immersed.

7. The method of claim 1, wherein each of sensing the first intensity of at least one of neutrons or photons and sensing the second intensity of at least one of neutrons or photons comprises sensing at least one of neutrons or photons emitted from a single fuel element of the reactor.

8. The method of claim 1, further comprising continuously measuring at least one of neutrons or photons as a function of time during the change in the operating parameter of the reactor.

9. The method of claim 8, wherein determining a mass of the fissile material within the reactor responsive to a difference between the first intensity and the second intensity comprises measuring a time between the change in the operating parameter of the reactor and a change in the at least one of neutrons or photons emitted therefrom.

10. The method of claim 1, further comprising identifying relative amounts of radioisotopes in the fissile material.

11. The method of claim 10, wherein identifying relative amounts of radioisotopes in the fissile material comprises identifying relative amounts of radioisotopes in the fissile material based at least in part on delayed neutron fraction and prompt neutron lifetime.

12. The method of claim 1, wherein determining a mass of the fissile material within the reactor comprises determining a mass of plutonium within the reactor.

13. The method of claim 1, wherein each of sensing the first intensity of at least one of neutrons or photons and sensing the second intensity of at least one of neutrons or photons comprises sensing Cherenkov radiation emitted from the reactor.

14. The method of claim 1, wherein each of sensing the first intensity of at least one of neutrons or photons and sensing the second intensity of at least one of neutrons or photons comprises sensing the first intensity and the second intensity emitted from each of a plurality of locations within the reactor.

15. The method of claim 1, wherein each of sensing the first intensity of at least one of neutrons or photons and sensing the second intensity of at least one of neutrons or photons comprises detecting a change in at least one of the first intensity and the second intensity over a period of time.

16. A system for determining an amount of fissile material in a reactor, the system comprising:
a radiation detector configured to detect at least one of neutrons or photons emitted from a reactor;
a computing system configured for operable communication with the radiation detector to receive a measurement corresponding to an intensity of the at least one of neutrons or photons, the computing system comprising:
a memory configured for storing computing instructions; and
a processor operably coupled to the memory and configured for executing the computing instructions to calculate a power output from the reactor based at least in part on the intensity of the at least one of neutrons or photons, wherein the processor is further configured for calculating a mass of fissile material within the reactor based at least in part on a change in the power output from the reactor as a function of time.

17. The system of claim 16, wherein the processor is configured for calculating relative amounts of radioisotopes in the fissile material based at least in part on the change in the power output from the reactor as a function of time.

18. The system of claim 16, wherein the processor is configured to compare the power output from the reactor to a theoretical power output based at least in part on a known composition and quantity of the fissile material.

19. The system of claim 16, wherein the radiation detector has a response time of less than about 1 millisecond.

20. The system of claim 16, wherein the radiation detector comprises at least one device selected from the group consisting of a photon flux monitor, an ionization chamber, a proportional counter, a neutron flux monitor, a fission chamber, a self-powered photon detector, a photodiode, a photomultiplier tube, a charge-coupled device, and a camera.

21. The system of claim 16, wherein the radiation detector comprises a plurality of sensors configured to detect at least one of neutrons or photons emitted from different locations within the reactor.

22. A method, comprising:
collecting an initial radiation measurement of emissions by a reactor;
generating a baseline electrical signal responsive to the collected initial radiation measurement;
changing a reactivity of the reactor;
sensing a change in radiation emitted by the reactor;
generating a second electrical signal responsive to the change in radiation during the change in the reactivity of the reactor; and
evaluating a mass of fissile material within the reactor responsive to a magnitude and response of the second electrical signal.

23. The method of claim 22, wherein evaluating a mass of the fissile material within the reactor comprises evaluating a variance of the second electrical signal as a function of time for a time period within 20 milliseconds after the change in reactivity of the reactor.

24. The method of claim 22, further comprising evaluating a composition of the fissile material within the reactor responsive to the magnitude and response of the second electrical signal.

25. The method of claim 22, wherein generating a second electrical signal responsive to the change in radiation during the change in the reactivity of the reactor comprises continuously generating the second electrical signal at least until the magnitude of the second electrical stabilizer stabilizes.
